(19) United States
(12) Patent Application Publication
(10) Pub. No.: US 2025/0265104 A1
(43) Pub. Date: Aug. 21, 2025

(54) VIRTUAL MACHINE DEPLOYMENT METHOD AND APPARATUS, DEVICE, AND READABLE STORAGE MEDIUM

(71) Applicant: INSPUR SUZHOU INTELLIGENT TECHNOLOGY CO., LTD., Jiangsu (CN)

(72) Inventor: Xinxin Shen, Shandong (CN)

(73) Assignee: INSPUR SUZHOU INTELLIGENT TECHNOLOGY CO., LTD., Jiangsu (CN)

(21) Appl. No.: 18/029,705

(22) PCT Filed: Sep. 28, 2021
(86) PCT No.: PCT/CN2021/121216

§ 371 Date: Sep. 7, 2023

(30) Foreign Application Priority Data
Nov. 12, 2020 (CN) 202011261567.6

(51) Int. Cl. G06F 9/455

(52) U.S. Cl. CPC G06F 9/45558; G06F 2009/4557

(57) ABSTRACT

A virtual machine deployment method and apparatus, a device, and a readable storage medium. The method uses a firefly algorithm to determine deployment locations of virtual machines, and takes an average performance score of all hosts to be selected as a target function. Locations of respective fireflies are locations of the respective hosts. An iterative optimization process of the firefly algorithm involves finding a host capable of maximizing operation performance of all hosts in a cloud platform after deployment of virtual machines is completed. Since the target function is the average performance score of all hosts after deployment of the virtual machines, selection of a host corresponding to the maximum target function value enables average performance of all hosts to be maximized after the virtual machines have been deployed to a destination host, thereby maximizing operation performance of all hosts in the cloud platform while scheduling the virtual machines.

### CROSS REFERENCE TO RELATED APPLICATIONS

This application claims priority to Chinese Patent Application No. 202011261567.6 filed on Nov. 12, 2020 and entitled “VIRTUAL MACHINE DEPLOYMENT METHOD AND APPARATUS, DEVICE, AND READABLE STORAGE MEDIUM”, the entire contents of which are incorporated herein by reference.

### TECHNICAL FIELD

The present application relates to the technical field of computers, and particularly relates to a virtual machine deployment method, apparatus and device, and a readable storage medium.

### BACKGROUND

Virtual machines in a cloud platform can be scheduled on different hosts. Generally, a less loaded host may be selected for deployment of a new virtual machine, or a virtual machine on a highly loaded host is transferred to a less loaded host, thereby balancing the load of the individual hosts as much as possible. Although scheduling the virtual machine in such a way can avoid overload or underload of the single host, it is difficult to guarantee the operation performance of all hosts in the cloud platform as it does not take into account the public service capability of the whole cloud platform.

Thus, how to maximize the operation performance of all hosts in the cloud platform while scheduling the virtual machines is a problem that needs to be addressed by those skilled in the art.

### SUMMARY

In view of this, the present application aims at providing a virtual machine deployment method, apparatus and device, and a readable storage medium to maximize the operation performance of all hosts in a cloud platform while scheduling virtual machines. The specific solution is as follows.

In a first aspect, the present application provides a virtual machine deployment method, including:
randomly setting locations of respective fireflies and initializing target parameters of the respective fireflies, wherein the locations of the respective fireflies are locations of respective to-be-selected hosts;
taking the respective fireflies separately as to-be-processed objects, and performing a function calculation step to obtain target function values corresponding to the respective fireflies; the function calculation step including: calculating a target function according to the location of each of the to-be-processed objects, wherein the target function can represent an average performance score of all the to-be-selected hosts after assuming that a virtual machine has been deployed to each of the to-be-processed objects;
determining whether a maximum number of iterations is reached;
if the maximum number of iterations is reached, determining a firefly corresponding to the largest target function value among all target function values as a destination firefly, determining a to-be-selected host corresponding to the destination firefly as a destination host, and deploying the virtual machine to the destination host; and

if the maximum number of iterations is not reached, updating the target parameters of the respective fireflies, updating the locations of the respective fireflies according to the updated target parameters, and re-performing the step of taking the respective fireflies separately as the to-be-processed objects and performing the function calculation step to obtain target function values corresponding to the respective fireflies.

In some embodiments, the calculation formula of the target function is:

$$F = {K}_{1}^{*} \frac{{f}_{p}}{\sqrt{{f}_{p}^{2} + {f}_{load}^{2} + {f}_{CPU}^{2}}} + {K}_{2}^{*} \frac{{f}_{load}}{\sqrt{{f}_{p}^{2} + {f}_{load}^{2} + {f}_{CPU}^{2}}} + {K}_{3}^{*} \frac{{f}_{CPU}}{\sqrt{{f}_{p}^{2} + {f}_{load}^{2} + {f}_{CPU}^{2}}}$$

wherein F is the target function; fₚ is an average power consumption of the to-be-selected hosts after assuming that the virtual machine has been deployed to each of the to-be-processed objects; f_{CPU} is an average CPU utilization rate of all the to-be-selected hosts after assuming that the virtual machine has been deployed to each of the to-be-processed objects; f_{load} is an average resource balance degree of all the to-be-selected hosts after assuming that the virtual machine has been deployed to each of the to-be-processed objects; and K₁, K₂ and K₃ are preset weight values, respectively.

In some embodiments, the average resource balance degree is calculated based on the average CPU utilization rate, an average memory utilization rate, an average disk utilization rate, and an average bandwidth utilization rate of all the to-be-selected hosts after assuming that the virtual machine has been deployed to each of the to-be-processed objects; and the calculation formula of the average resource balance degree is:

$$\{ \begin{matrix}{f}_{load} = \frac{4}{{( \frac{{u}_{cpu}}{u} )}^{2} + {( \frac{{u}_{mem}}{u} )}^{2} + {( \frac{{u}_{hw}}{u} )}^{2} + {( \frac{{u}_{disk}}{u} )}^{2}} \\ u = \frac{{u}_{cpu} + {u}_{mem} + {u}_{hw} + {u}_{disk}}{4}\end{matrix}$$

wherein f_{load} is the average resource balance degree, u_{cpu} is the average CPU utilization rate, uₘₑₘ is the average memory utilization rate, u_{hw} is the average bandwidth utilization rate, and u_{disk} is the average disk utilization rate.

In some embodiments, the target parameter includes fluorescein and a step length. The step of updating the target parameters of the respective fireflies includes:
updating fluorescein of the respective fireflies with a first formula, wherein the first formula is:

$${l}_{i} ( t + 1 ) = ( 1 - ρ ) {l}_{i} ( t ) + γ {F}_{i} ( t + 1 )$$

updating step lengths of the respective fireflies with a second formula, wherein the second formula is:

$$\{ \begin{matrix}{s}_{i} ( t + 1 ) = {s}_{min} + {( ( {s}_{max} - {s}_{min} ) {l}_{i} ( t ) )}^{c} \\ c = 1 + \frac{t + 1}{{t}_{max}} - cos ( \frac{t + 1}{{t}_{max}} )\end{matrix}$$

wherein lᵢ(t+1) is fluorescein of a firefly i at the (t+1)^{th} iteration, ρ(0<ρ<1) is a fluorescein volatilization speed of the firefly i, lᵢ(t) is fluorescein of the firefly i at the t^{th} iteration, γ is a fluorescein update rate of the firefly i, Fᵢ(t+1) is a target function value of the firefly i at the (t+1)^{th} iteration, sᵢ(t+1) is a step length of the firefly i at the (t+1)^{th} iteration, sₘᵢₙ is a preset minimum step length, sₘₐₓ is a preset maximum step length, t+1 is the current number of iterations, and tₘₐₓ is the maximum number of iterations.

In some embodiments, the step of updating the locations of the respective fireflies according to the updated target parameters includes:
updating the locations of the respective fireflies with a third formula, wherein the third formula is:

$${x}_{i} ( t + 1 ) = {x}_{i} ( t ) + {s}_{i} ( t + 1 ) ( \frac{{x}_{j} ( t ) - {x}_{i} ( t )}{‖ {x}_{j} ( t ) - {x}_{i} ( t ) ‖} )$$

wherein xᵢ(t+1) is a location of the firefly i at the (t+1)^{th} iteration, xᵢ(t) is a location of the firefly i at the t^{th} iteration, sᵢ(t+1) is the step length of the firefly i at the (t+1)^{th} iteration, xⱼ(t) is a location of a firefly j at the t^{th} iteration, and ∥xⱼ(t)−xᵢ(t)∥ is a Euclidean distance between the location of the firefly i and the location of the firefly j; and
wherein the firefly j is a neighbor firefly selected within a decision domain of the firefly i at the t^{th} iteration based on the roulette rule, and the fluorescein of the firefly j is greater than the fluorescein of the firefly i.

In some embodiments, the target parameter further includes a decision domain. Decision domains of the respective fireflies are updated with a fourth formula, wherein the fourth formula is:

$${r}_{d}^{i} ( t + 1 ) = min \{ {r}_{s} , max \{ 0 , {r}_{d}^{i} ( t ) + β ( {n}_{i} - \vert N , ( t ) \vert ) \} \}$$

wherein r_{d}ⁱ(t+1) is a decision domain of the firefly i at the (t+1)^{th} iteration, rₛ is a preset perceptual domain, r_{d}ⁱ(t) is a decision domain of the firefly i at the t^{th} iteration, β is a dynamic decision domain update rate, nᵢ is a neighborhood set threshold, Nᵢ(t) is a neighborhood set of the firefly i at the t^{th} iteration.

In some embodiments, normalization is performed on the average power consumption, the average CPU utilization rate, and the average resource balance degree, wherein a normalization formula is:

$$\text{?}$$

$$\text{?} \text{indicates text missing or illegible when filed}$$

wherein fₚ is the average power consumption after normalization, f_{p_o} is the average power consumption before normalization, f_{p_min} is a minimum average power consumption, and f_{p_max} is a maximum average power consumption; f_{cpu} is the average CPU utilization rate after normalization, f_{cpu_o} is the average CPU utilization rate before normalization, f_{cpu_min} is a minimum average CPU utilization rate, f_{cpu_max} is a maximum average CPU utilization rate; f_{load} is the average resource balance degree after normalization, f_{load_o} is the average resource balance degree before normalization, f_{load_min} is a minimum average resource balance degree, and f_{load_max} is a maximum average resource balance degree.

In a second aspect, the present application provides a virtual machine deployment apparatus, including:
an initialization module, configured to randomly set locations of respective fireflies and initialize target parameters of the respective fireflies, wherein the locations of the respective fireflies are locations of respective to-be-selected hosts;
a function calculation module, configured to take the respective fireflies separately as to-be-processed objects, and perform a function calculation step to obtain target function values corresponding to the respective fireflies; the function calculation step including: calculating a target function according to the location of each of the to-be-processed objects, wherein the target function can represent an average performance score of all the to-be-selected hosts after assuming that a virtual machine has been deployed to each of the to-be-processed objects;
a determination module, configured to determine whether a maximum number of iterations is reached;
a deployment module, configured to, if the maximum number of iterations is reached, determine a firefly corresponding to the largest target function value among all the target function values as a destination firefly, determine a to-be-selected host corresponding to the destination firefly as a destination host, and deploy the virtual machine to the destination host; and
an iteration module, configured to, if the maximum number of iterations is not reached, update the target parameters of the respective fireflies, update the locations of the respective fireflies according to the updated target parameters, and re-perform the step of taking the respective fireflies separately as the to-be-processed objects and performing the function calculation step to obtain target function values corresponding to the respective fireflies.

In a third aspect, the present application provides a virtual machine deployment device, including:
a memory, configured to store a computer program; and
a processor, configured to execute the computer program to implement the virtual machine deployment method disclosed above.

In a fourth aspect, the present application provides a readable storage medium, configured to store a computer program, wherein the computer program, when executed by a processor, implements the virtual machine deployment method disclosed above.

It can be from the above solution that the present application provides a virtual machine deployment method, including: randomly setting locations of respective fireflies and initializing target parameters of the respective fireflies, wherein the locations of the respective fireflies are locations of respective to-be-selected hosts; taking the respective fireflies separately as to-be-processed objects, and performing a function calculation step to obtain target function values corresponding to the respective fireflies; the function calculation step including: calculating a target function according to the location of each of the to-be-processed objects, wherein the target function can represent an average performance score of all the to-be-selected hosts after assuming that a virtual machine has been deployed to each of the to-be-processed objects; determining whether a maximum number of iterations is reached; if the maximum number of iterations is reached, determining a firefly corresponding to the largest target function value among all target function values as a destination firefly, determining a to-be-selected host corresponding to the destination firefly as a destination host, and deploying the virtual machine to the destination host; and if the maximum number of iterations is not reached, updating the target parameters of the respective fireflies, updating the locations of the respective fireflies according to the updated target parameters, and re-performing the step of taking the respective fireflies separately as the to-be-processed objects and performing the function calculation step to obtain target function values corresponding to the respective fireflies.

As can be seen, according to the present application, a firefly algorithm is utilized to determine deployment locations of virtual machines, the average performance score of all the to-be-selected hosts is taken as the target function, and the locations of the respective fireflies are locations of the respective to-be-selected hosts. Therefore, an iterative optimization process of the firefly algorithm is as follows: finding a host capable of maximizing the operation performance of all the hosts in the cloud platform after the virtual machine is deployed. Since the target function is the average performance score of all the to-selected hosts after the virtual machines are deployed, the to-be-selected host corresponding to the maximum target function value is selected to maximize the average performance of all the to-be-selected hosts after the virtual machine has deployed to the destination host, thereby maximizing the operation performance of all hosts in the cloud platform while scheduling the virtual machines.

Accordingly, the present application provides a virtual machine deployment apparatus and device, and a readable storage medium, which also have the above technical effects

### BRIEF DESCRIPTION OF THE DRAWINGS

In order to illustrate more clearly the technical solutions in the embodiments of the present application or in the prior art, the drawings required for the description of the embodiments or prior art will now be briefly described below. Obviously, the drawings in the following description are merely embodiments of the present application, and a person of ordinary skill in the art may also obtain other drawings according to the provided drawings without inventive step.

FIG. 1 is a flowchart illustrating a virtual machine deployment method according to the present application;

FIG. 2 is a flowchart illustrating a method for solving a target function using a firefly algorithm according to the present application;

FIG. 3 is a schematic diagram of a virtual machine deployment apparatus according to the present application; and

FIG. 4 is a schematic diagram of a virtual machine deployment device according to the present application.

### DETAILED DESCRIPTION

The technical solutions in the embodiments of the present application will be clearly and completely described below in conjunction with drawings in the embodiments of the present application. Obviously, the described embodiments are only a part of the embodiments of the present application, not all of the embodiments. Based on the embodiments in the present application, all other embodiments acquired by a person of ordinary skill in the art without creative work shall fall within the protection scope of the present application.

Prior to the introduction of the present application, the relevant background art is introduced as follows.

In general, virtual machines need to be scheduled in the following three scenarios. I: A user creates a new virtual machine, and selects a physical host to which the virtual machine is deployed. II: If there are excessive virtual machines on one physical host to result in overload, part of the virtual machines on the physical host need to be transferred to other physical hosts. Alternatively, if there are too few virtual machines on one physical host to result in underload, virtual machines on other physical hosts need to be transferred to the current physical host in order to achieve load balance. III: If the physical host fails, virtual machines on the physical host need to be transferred to other physical hosts. Unreasonable scheduling strategies may cause multiple transfers of virtual machines across physical hosts, severely impacting the stability of the entire cloud platform. Moreover, the resources and applications requested by each user using the cloud platform are different, and loads on the respective physical hosts are also different, resulting in instability in resource usage by the cloud platform.

At present, an ant colony optimization algorithm can be used to find a target host for deploying the virtual machine. However, the anti colony optimization algorithm has the problems of low solution speed and the difficulty in ensuring the quality of the obtained solution, the calculation amount is large, the convergence speed is low; and it is easy to fall into local optimization, which cannot maximize the operation performance of all hosts in the cloud platform while scheduling the virtual machines. To this end, the present application provides a virtual machine deployment solution that maximizes the operation performance of all hosts in a cloud platform while scheduling virtual machines.

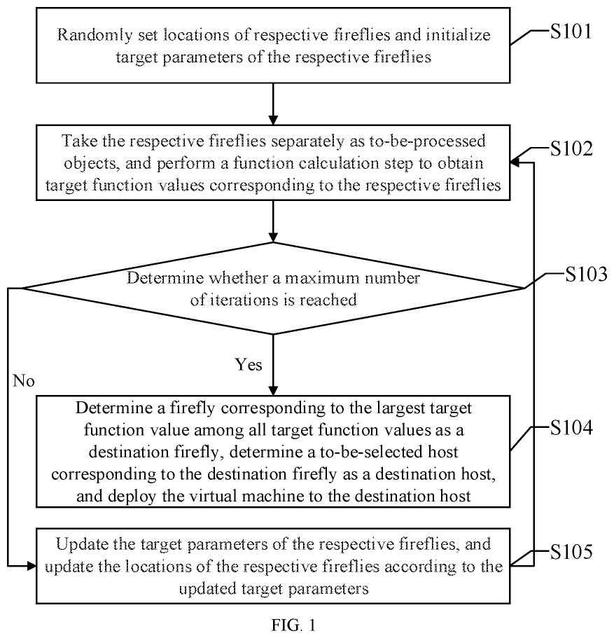

Referring to FIG. 1, an embodiment of the present application discloses a virtual machine deployment method including the following steps.

S101, locations of respective fireflies are randomly set, and target parameters of the respective fireflies are initialized.

The locations of the respective fireflies are the locations of respective to-be-selected hosts. The quantity of the locations of the fireflies is equal to the quantity of to-be-selected hosts, but the quantity of the fireflies and the quantity of the to-be-selected hosts may be equal or may not be equal. If the quantity of the fireflies is greater than the quantity of the to-be-selected hosts, a plurality of fireflies may be gathered at one location of the firefly.

S102, the respective fireflies are separately taken as to-be-processed objects, and a function calculation step is performed to obtain target function values corresponding to the respective fireflies.

The function calculation step includes: calculating a target function according to the location of each of the to-be-processed objects, wherein the target function can represent an average performance score of all the to-be-selected hosts after assuming that a virtual machine has been deployed to each of the to-be-processed objects.

In a specific embodiment, the calculation formula of the target function is:

$$F = {K}_{1} * \frac{{f}_{p}}{\sqrt{{f}_{p}^{2} + {f}_{load}^{2} + {f}_{CPU}^{2}}} + {K}^{2} * \frac{{f}_{load}}{\sqrt{{f}_{p}^{2} + {f}_{load}^{2} + {f}_{CPU}^{2}}} + {K}_{3} * \frac{{f}_{CPU}}{\sqrt{{f}_{p}^{2} + {f}_{load}^{2} + {f}_{CPU}^{2}}}$$

wherein F is the target function; fₚ is an average power consumption of the to-be-selected hosts after assuming that the virtual machine has been deployed to each of the to-be-processed objects; f_{CPU} is an average CPU utilization rate of all the to-be-selected hosts after assuming that the virtual machine has been deployed to each of the to-be-processed objects; f_{load} is an average resource balance degree of all the to-be-selected hosts after assuming that the virtual machine has been deployed to each of the to-be-processed objects; and K₁, K₂ and K₃ are preset weight values, respectively. The greater preset weight value indicates that the cloud platform currently focuses on its corresponding parameter (power consumption, CPU utilization rate, or resource balance degree).

For example, it is considered that a firefly A corresponds to a to-be-selected host A, and assuming that a virtual machine is deployed to the to-be-selected host A, the power consumption, CPU utilization rate and resource balance degree of the to-be-selected host A are adjusted based on the power consumption, CPU utilization rate, bandwidth utilization rate, memory utilization rate, and other relevant parameters of the virtual machine. Then, the average power consumption, average CPU utilization rate, and average resource balance degree of all the to-be-selected hosts (including the to-be-selected host A to which the virtual machine is deployed) are calculated. The greater F indicates better average performance of all the to-be-selected hosts.

In a specific embodiment, the average resource balance degree is calculated based on the average CPU utilization rate, an average memory utilization rate, an average disk utilization rate, and an average bandwidth utilization rate of all the to-be-selected hosts at a certain moment after assuming that the virtual machine has been deployed to each of the to-be-processed objects. The calculation formula of the average resource balance degree is:

$$\{ \begin{matrix}{f}_{load} = \frac{4}{{( \frac{{u}_{cpu}}{u} )}^{2} + {( \frac{{u}_{mem}}{u} )}^{2} + {( \frac{{u}_{hw}}{u} )}^{2} + {( \frac{{u}_{disk}}{u} )}^{2}} \\ u = \frac{{u}_{cpu} + {u}_{mem} + {u}_{hw} + {u}_{disk}}{4}\end{matrix}$$

wherein f_{load} is the average resource balance degree, u_{cpu} is the average CPU utilization rate, uₘₑₘ is the average memory utilization rate, u_{hw} is the average bandwidth utilization rate, and u_{disk} is the average disk utilization rate.

In a specific embodiment, normalization is performed on the average power consumption, the average CPU utilization rate, and the average resource balance degree, wherein a normalization formula is:

$$\text{?}$$

$$\text{?} \text{indicates text missing or illegible when filed}$$

wherein fₚ is the average power consumption after normalization, f_{p_o} is the average power consumption before normalization, f_{p_min} is a minimum average power consumption, and f_{p_max} is a maximum average power consumption; f_{cpu} is the average CPU utilization rate after normalization, f_{cpu_o} is the average CPU utilization rate before normalization, f_{cpu_min} is a minimum average CPU utilization rate, f_{cpu_max} is a maximum average CPU utilization rate; f_{load} is the average resource balance degree after normalization, f_{load_o} is the average resource balance degree before normalization, f_{load_min} is a minimum average resource balance degree, and f_{load_max} is a maximum average resource balance degree. The average power consumption, average CPU utilization rate, and average resource balance degree after normalization take values between 0 and 1.

S103, whether a maximum number of iterations is reached is determined; if the maximum number of iterations is reached, S104 is performed; and if the maximum number of iterations is not reached, S105 is performed.

S104, a firefly corresponding to the largest target function value among all target function values is determined as a destination firefly, a to-be-selected host corresponding to the destination firefly is determined as a destination host, and the virtual machine is deployed to the destination host.

S105, the target parameters of the respective fireflies are updated, the locations of the respective fireflies are updated according to the updated target parameters, and S102 is re-performed.

In a specific embodiment, the target parameter includes fluorescein and a step length. The step that the target parameters of the respective fireflies are updated includes:
updating fluorescein of the respective fireflies with a first formula, wherein the first formula is:

$${l}_{i} ( t + 1 ) = ( 1 - ρ ) {l}_{i} ( t ) + γ {F}_{i} ( t + 1 )$$

updating step lengths of the respective fireflies with a second formula, wherein the second formula is:

$$\{ \begin{matrix}{s}_{i} ( t + 1 ) = {s}_{min} + {( ( {s}_{max} - {s}_{min} ) {l}_{i} ( t ) )}^{c} \\ c = 1 + \frac{t + 1}{{t}_{max}} - cos ( \frac{t + 1}{{t}_{max}} )\end{matrix}$$

wherein lᵢ(t+1) is fluorescein of a firefly i at the (t+1)^{th} iteration, i.e, fluorescein updated currently; ρ(0<ρ<1) is a fluorescein volatilization speed of the firefly i; lᵢ(t) is fluorescein of the firefly i at the t^{th} iteration; γ is a fluorescein update rate of the firefly i; Fᵢ(t+1) is a target function value of the firefly i at the (t+1)^{th} iteration; sᵢ(t+1) is a step length of the firefly i at the (t+1)^{th} iteration, i.e, a step length updated currently; sₘᵢₙ is a preset minimum step length that takes a value close to 0; sₘₐₓ is a preset maximum step length that takes a value close to 1; t+1 is the current number of iterations; and tₘₐₓ is the maximum number of iterations.

It is noted that the step length of each of the fireflies varies with increasing number of iterations, thereby ensuring that the step length of each of the fireflies remains within a reasonable range.

In a specific embodiment, the step that the locations of the respective fireflies are updated according to the updated target parameters includes:

updating the locations of the respective fireflies with a third formula, wherein the third formula is:

$${x}_{i} ( t + 1 ) = {x}_{i} ( t ) + {s}_{i} ( t + 1 ) ( \frac{{x}_{j} ( t ) - {x}_{i} ( t )}{‖ {x}_{j} ( t ) - {x}_{i} ( t ) ‖} )$$

wherein xᵢ(t+1) is a location of the firefly i at the (t+1)^{th} iteration, xᵢ(t) is a location of the firefly i at the t^{th} iteration, sᵢ(t+1) is the step length of the firefly i at the (t+1)^{th} iteration, xⱼ(1) is a location of a firefly j at the t^{th} iteration, and ∥xⱼ(t)−xᵢ(t)∥ is a Euclidean distance between the location of the firefly i and the location of the firefly j; and
wherein the firefly j is a neighbor firefly selected within a decision domain of the firefly i at the t^{th} iteration based on the roulette rule, and the fluorescein of the firefly j is greater than the fluorescein of the firefly i.

In a specific embodiment, the target parameter further includes a decision domain. Decision domains of the respective fireflies are updated with a fourth formula, wherein the fourth formula is:

$${r}_{d}^{i} ( t + 1 ) = min \{ {r}_{s} , max \{ 0 , {r}_{d}^{i} ( t ) + β ( {n}_{i} - \vert {N}_{i} ( t ) \vert ) \} \}$$

wherein r_{d}ⁱ(t+1) is a decision domain of the firefly i at the (t+1)^{th} iteration, rₛ is a preset perceptual domain, r_{d}ⁱ(t) is a decision domain of the firefly i at the t^{th} iteration, β is a dynamic decision domain update rate, nᵢ is a neighborhood set threshold, and Nᵢ(t) is a neighborhood set of the firefly i at the t^{th} iteration, i.e, the quantity of neighbor fireflies in the decision domain of the firefly i at the t^{th} iteration.

As can be seen, according to the embodiments of the present application, a firefly algorithm is utilized to determine deployment locations of the virtual machines, the average performance score of all the to-be-selected hosts is taken as the target function, and the locations of the respective fireflies are locations of the respective to-be-selected hosts. Therefore, an iterative optimization process of the firefly algorithm is as follows: finding a host capable of maximizing the operation performance of all the hosts in the cloud platform after the virtual machine is deployed. Since the target function is the average performance score of all the to-selected hosts after the virtual machines are deployed, the to-be-selected host corresponding to the maximum target function value is selected to maximize the average performance of all the to-be-selected hosts after the virtual machine has deployed to the destination host, thereby maximizing the operation performance of all hosts in the cloud platform while scheduling the virtual machines.

An embodiment of the present application discloses a virtual machine deployment solution, including defining a target function, solving a target function, and deploying virtual machines.
1. Assuming that a virtual machine has been deployed to each of to-be-selected hosts, a target function F is defined:

$$F = {K}_{1} * \frac{{f}_{p}}{\sqrt{{f}_{p}^{2} + {f}_{load}^{2} + {f}_{CPU}^{2}}} + {K}^{2} * \frac{{f}_{load}}{\sqrt{{f}_{p}^{2} + {f}_{load}^{2} + {f}_{CPU}^{2}}} + {K}_{3} * \frac{{f}_{CPU}}{\sqrt{{f}_{p}^{2} + {f}_{load}^{2} + {f}_{CPU}^{2}}}$$

wherein fₚ is an average power consumption of the respective to-be-selected hosts; f_{CPU} is an average CPU utilization rate of all the to-be-selected hosts; f_{load} is an average resource balance degree of all the to-be-selected hosts; and K₁, K₂ and K_{3 a}re preset weight values, respectively.

$$\{ \begin{matrix}{f}_{load} = \frac{4}{{( \frac{{u}_{cpu}}{u} )}^{2} + {( \frac{{u}_{mem}}{u} )}^{2} + {( \frac{{u}_{hw}}{u} )}^{2} + {( \frac{{u}_{disk}}{u} )}^{2}} \\ u = \frac{{u}_{cpu} + {u}_{mem} + {u}_{hw} + {u}_{disk}}{4}\end{matrix}$$

wherein f_{load} is the average resource balance degree, u_{cpu} is the average CPU utilization rate, uₘₑₘ is an average memory utilization rate, u_{hw} is an average bandwidth utilization rate, and u_{disk} is an average disk utilization rate.

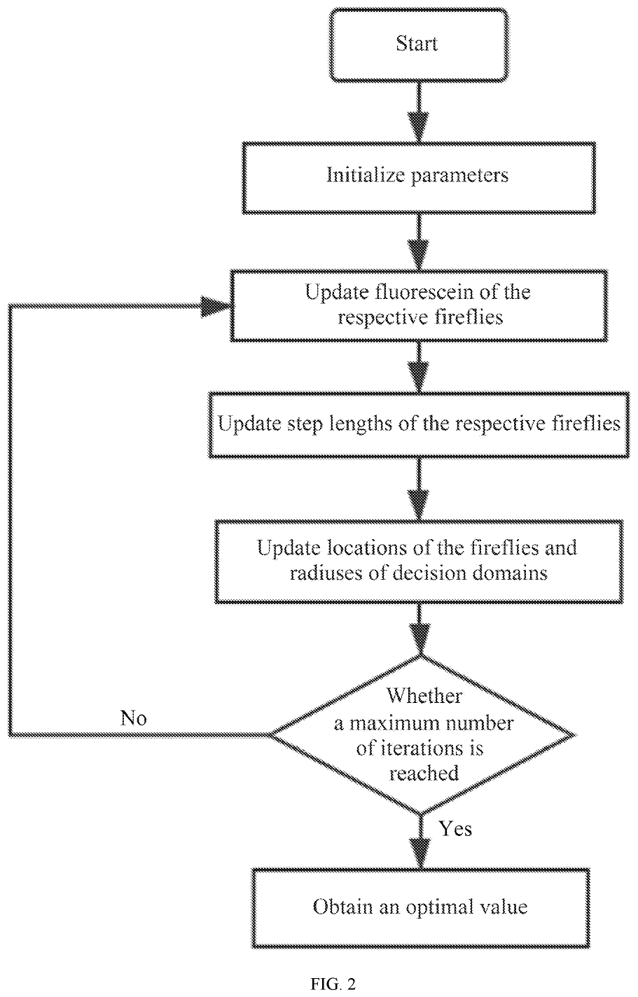

fₚ, f_{cpu} and f_{load} are all values after normalization and a normalization formula is:

$$\text{?}$$

$$\text{?} \text{indicates text missing or illegible when filed}$$

wherein fₚ is the average power consumption after normalization, f_{p_o} is the average power consumption before normalization, f_{p_min} is a minimum average power consumption, and f_{p_max} is a maximum average power consumption; f_{cpu} is the average CPU utilization rate after normalization, f_{cpu_o} is the average CPU utilization rate before normalization, f_{cpu_min} is a minimum average CPU utilization rate, f_{cpu_max} is a maximum average CPU utilization rate; f_{load} is the average resource balance degree after normalization, f_{load_o} is the average resource balance degree before normalization, f_{load_min} is a minimum average resource balance degree, and f_{load_max} is a maximum average resource balance degree.
2. Referring to FIG. 2, the target function is solved using the firefly algorithm.
(1) Parameters are initialized.

Locations of respective fireflies are initialized; and the locations of the respective fireflies are the locations of the respective to-be-selected hosts.

Target parameters, such as fluorescein, step length and decision domain, of the respective fireflies are initialized.

respective preset values, such as fluorescein volatilization speed ρ(0<ρ<1), fluorescein update rate γ, minimum step length sₘᵢₙ, maximum step length sₘₐₓ, maximum number of iterations tₘₐₓ, perceptual domain rₛ, neighborhood set threshold nᵢ, are set.
(2) Assuming that a virtual machine has been deployed to each of the to-be-selected hosts respectively, target function values corresponding to the respective fireflies are calculated based on the current locations of the fireflies. The larger the target function values, the better the average performance of all the to-be-selected hosts.
(3) Fluorescein of the respective fireflies is updated.

The fluorescein of the firefly is directly related to its location. The greater the fluorescein, the higher the fitness value of its location. The size of the fluorescein is also related to the size of the fluorescein in the previous iteration and its volatilization speed, as well as the target function value, wherein an update formula is:

$${l}_{i} ( t + 1 ) = ( 1 - ρ ) {l}_{i} ( t ) + γ {F}_{i} ( t + 1 )$$

wherein lᵢ(t+1) is fluorescein of a firefly i at the (t+1)^{th} iteration, i.e, fluorescein updated currently; ρ(0<ρ<1) is a fluorescein volatilization speed of the firefly i; lᵢ(t) is fluorescein of the firefly i at the t^{th} iteration; γ is a fluorescein update rate of the firefly i; and Fᵢ(t+1) is a target function value of the firefly i at the (t+1)^{th} iteration.
(4) Step lengths of the respective fireflies are updated.

The step length remains greater at the initial stage of iteration in the algorithm. In order to avoid falling into local optimization due to premature maturation of the algorithm, at the later stage of iteration in the algorithm, the step length is gradually reduced to avoid skipping the optimal solution at the later stage of iteration in the algorithm due to the excessively greater step length. A step length update formula is:

$$\{ \begin{matrix}{s}_{i} ( t + 1 ) = {s}_{min} + {( ( {s}_{max} - {s}_{min} ) {l}_{i} ( t ) )}^{c} \\ c = 1 + \frac{t + 1}{{t}_{max}} - cos ( \frac{t + 1}{{t}_{max}} )\end{matrix}$$

wherein sᵢ(t+1) is a step length of the firefly i at the (t+1)^{th} iteration, i.e, a step length updated currently; sₘᵢₙ is a preset minimum step length that takes a value close to 0; sₘₐₓ is a preset maximum step length that takes a value close to 1; lᵢ(t) is fluorescein of the firefly i at the t^{th} iteration; t+1 is the current number of iterations; and tₘₐₓ is the maximum number of iterations.
(5) The locations of the respective fireflies are updated.

An eligible neighbor firefly needs to be found first before each of the fireflies moves according to the step length. The condition for finding the neighbor firefly is as follows: the location of the neighbor firefly is within the decision domain of the current firefly, and the fluorescein of the neighbor firefly is greater than the fluorescein of the current firefly. Neighbor fireflies satisfying the above condition are combined to form a neighborhood set, and the probability of each neighbor firefly in the neighborhood set is calculated according to the following formula:

$${p}_{ij} = \frac{{l}_{j} ( t ) - {l}_{i} ( t )}{{\sum }_{k ∈ {N}_{i} ( t )} {l}_{k} ( t ) - {l}_{i} ( t )}$$

wherein j∈Nᵢ(t), Nᵢ(t)={j;d_{i,j}(t)<r_{d}ⁱ(t);lᵢ(t)<lⱼ(t)}, Nᵢ(t) is the neighborhood set of any firefly i at the t^{th} iteration, d_{i,j}(t)=∥xⱼ(t−xᵢ(t)∥ is a Euclidean distance between the firefly i and a firefly j at the t^{th} iteration.

Based on the probability of each neighbor firefly, a neighbor firefly j is selected using the roulette rule, and then the spatial location of the firefly i is updated according to the following formula:

$${x}_{t} ( t + 1 ) = {x}_{t} ( t ) + {s}_{t} ( t + 1 ) ( \frac{( {x}_{j} ( t ) - {x}_{i} ( t ) )}{‖ {x}_{j} ( t ) - {x}_{i} ( t ) ‖} )$$

wherein xᵢ(t+1) is a location of the firefly i at the (t+1)^{th} iteration, xᵢ(t) is a location of the firefly i at the t^{th} iteration, sᵢ(t+1) is the step length of the firefly i at the (t+1)^{th} iteration, xᵢ(t) is a location of a firefly j at the t^{th} iteration, and ∥xⱼ(t)−xᵢ(t)∥ is a Euclidean distance between the location of the firefly i and the location of the firefly j.
(6) Decision domains of the respective fireflies are updated.

After the locations of the fireflies are updated, the decision domains of the fireflies are further updated, wherein an update formula is:

$${r}_{d}^{i} ( t + 1 ) = min \{ {r}_{s} , max \{ 0 , {r}_{d}^{i} ( t ) + β ( {n}_{i} - \vert {N}_{i} ( t ) ) \} \}$$

wherein r_{d}ⁱ(t+1) is a decision domain of the firefly i at the (t+1)^{th} iteration, rₛ is a preset perceptual domain, r_{d}ⁱ(t) is a decision domain of the firefly i at the t^{th} iteration, β is a dynamic decision domain update rate, nᵢ is a neighborhood set threshold, and Nᵢ(t) is a neighborhood set of the firefly i at the t^{th} iteration, i.e. the quantity of neighbor fireflies in the decision domain of the firefly i at the t^{th} iteration.
(7) The number of iterations at the moment is determined.

If the current number of iterations is greater than the maximum number of iteration/max. iteration ends, the target function values are calculated using the latest locations of the fireflies, and the maximum target function value and the corresponding firefly location are selected for output. If the current number of iterations is less than the maximum number of iterations tₘₐₓ, step (2) is re-performed for the next iteration until the constraint on the number of iterations is satisfied.
3. A virtual machine is deployed: the location of the firefly corresponding to the maximum target function value corresponds is the deployment location of the virtual machine, wherein the virtual machine is deployed to the location, which maximizes the operation performance of all the to-be-selected hosts.

As can be seen, in the embodiment, the target function capable of indicating the average performance score of all the to-be-selected hosts is defined by taking into account the resource balance degree obtained based on the CPU utilization rate, the memory utilization rate, the bandwidth utilization rate, and the disk utilization rate, in conjunction with normalization of the CPU utilization rate and the power consumption. Solving the target function using a modified firefly algorithm takes into account the influence of the size of fluorescein as well as the step length on the iteration process, such that the algorithm has strong local search capability, can find the optimal solution for that region within a smaller region, is convenient to operate, and easy to implement. Moreover, since there are parameters for the firefly algorithm, the influence of the parameters on the algorithm is slight. The firefly algorithm used by the embodiment can present the individual from oscillation near the peak, and an optimal physical host location is output after iterative optimization to serve as the destination physical host of the virtual machine, such that the cloud platform can maintain high CPU utilization rate, lower energy consumption, and resource balance after the virtual machine is deployed to improve overall system performance.

A virtual machine deployment apparatus provided by an embodiment of the present application will be described below; which can refer to the virtual machine deployment method described above.

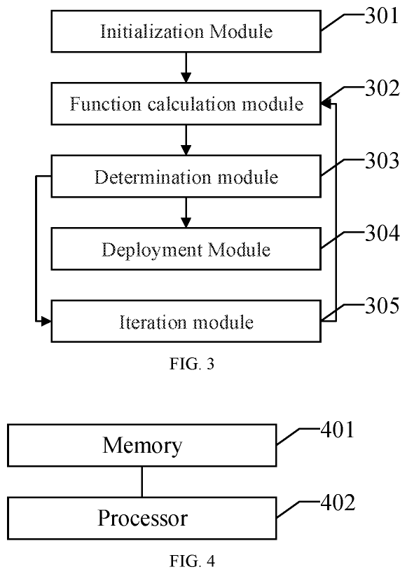

Referring to FIG. 3, an embodiment of the present application discloses a virtual machine deployment apparatus, including:
an initialization module 301, configured to randomly set locations of respective fireflies and initialize target parameters of the respective fireflies, wherein the locations of the respective fireflies are locations of respective to-be-selected hosts;
a function calculation module 302, configured to take the respective fireflies separately as to-be-processed objects, and perform a function calculation step to obtain target function values corresponding to the respective fireflies; the function calculation step including: calculating a target function according to the location of each of the to-be-processed objects, wherein the target function can represent an average performance score of all the to-be-selected hosts after assuming that a virtual machine has been deployed to each of the to-be-processed objects;
a determination module 303, configured to determine whether a maximum number of iterations is reached;
a deployment module 304, configured to, if the maximum number of iterations is reached, determine a firefly corresponding to the largest target function value among all the target function values as a destination firefly, determine a to-be-selected host corresponding to the destination firefly as a destination host, and deploy the virtual machine to the destination host; and
an iteration module 305, configured to, if the maximum number of iterations is not reached, update the target parameters of the respective fireflies, update the locations of the respective fireflies according to the updated target parameters, and re-perform the step of taking the respective fireflies separately as the to-be-processed objects and performing the function calculation step to obtain target function values corresponding to the respective fireflies.

In a specific embodiment, the calculation formula of the target function is:

$$F = {K}_{1} * \frac{{f}_{p}}{\sqrt{{f}_{p}^{2} + {{f}_{load}}^{2} + {{f}_{CPU}}^{2}}} + {K}_{2} * \frac{{f}_{load}}{\sqrt{{f}_{p}^{2} + {{f}_{load}}^{2} + {{f}_{CPU}}^{2}}} + {K}_{3} * \frac{{f}_{CPU}}{\sqrt{{f}_{p}^{2} + {{f}_{load}}^{2} + {{f}_{CPU}}^{2}}}$$

wherein F is the target function; fₚ is an average power consumption of the to-be-selected hosts after assuming that the virtual machine has been deployed to each of the to-be-processed objects; f_{CPU} is an average CPU utilization rate of all the to-be-selected hosts after assuming that the virtual machine has been deployed to each of the to-be-processed objects; f_{load} is an average resource balance degree of all the to-be-selected hosts after assuming that the virtual machine has been deployed to each of the to-be-processed objects; and K₁, K₂ and K₃ are preset weight values, respectively.

In a specific embodiment, the average resource balance degree is calculated based on the average CPU utilization rate, an average memory utilization rate, an average disk utilization rate, and an average bandwidth utilization rate of all the to-be-selected hosts after assuming that the virtual machine has been deployed to each of the to-be-processed objects. The calculation formula of the average resource balance degree is:

$$\{ \begin{matrix}{f}_{load} = \frac{4}{{( \frac{{u}_{cpu}}{u} )}^{2} + {( \frac{{u}_{mem}}{u} )}^{2} + {( \frac{{u}_{hw}}{u} )}^{2} + {( \frac{{u}_{disk}}{u} )}^{2}} \\ u = \frac{{u}_{cpu} + {u}_{mem} + {u}_{hw} + {u}_{disk}}{4}\end{matrix}$$

wherein f_{load} is the average resource balance degree, u_{cpu} is the average CPU utilization rate, uₘₑₘ is the average memory utilization rate, u_{hw} is the average bandwidth utilization rate, and u_{disk} is the average disk utilization rate.

In a specific embodiment, the target parameter includes fluorescein and a step length, and the iteration module is specifically configured to:
update fluorescein of the respective fireflies with a first formula, wherein the first formula is:

$${l}_{i} ( t + 1 ) = ( 1 - ρ ) {l}_{i} ( t ) + γ {F}_{i} ( t + 1 ) ;$$

update step lengths of the respective fireflies with a second formula, wherein the second formula is:

$$\{ \begin{matrix}{s}_{i} ( t + 1 ) = {s}_{min} + {( ( {s}_{max} - {s}_{min} ) {l}_{i} ( t ) )}^{c} \\ c = 1 + \frac{t + 1}{{t}_{max}} - cos ( \frac{t + 1}{{t}_{max}} )\end{matrix}$$

wherein lᵢ(t+1) is fluorescein of a firefly i at the (t+1)^{th} iteration, ρ(0<ρ<1) is a fluorescein volatilization speed of the firefly i, lᵢ(t) is fluorescein of the firefly i at the t^{th} iteration, γ is a fluorescein update rate of the firefly i, Fᵢ(t+1) is a target function value of the firefly i at the (t+1)^{th} iteration, sᵢ(t+1) is a step length of the firefly i at the (t+1)^{th} iteration, sₘᵢₙ is a preset minimum step length, sₘₐₓ is a preset maximum step length, t+1 is the current number of iterations, and tₘₐₓ is the maximum number of iterations.

In a specific embodiment, the iteration module is specifically configured to:
update the locations of the respective fireflies with a third formula, wherein the third formula is:

$${x}_{i} ( t + 1 ) = {x}_{i} ( t ) + {s}_{i} ( t + 1 ) ( \frac{{x}_{j} ( t ) - {x}_{i} ( t )}{‖ {x}_{j} ( t ) - {x}_{i} ( t ) ‖} )$$

wherein xᵢ(t+1) is a location of the firefly i at the (t+1)^{th} iteration, xᵢ(t) is a location of the firefly i at the t^{th} iteration, sᵢ(t+1) is the step length of the firefly i at the (t+1)^{th} iteration, xⱼ(t) is a location of a firefly j at the t^{th} iteration, and ∥xᵢ(t)−xᵢ(t)∥ is a Euclidean distance between the location of the firefly i and the location of the firefly j; and
wherein the firefly j is a neighbor firefly selected within a decision domain of the firefly i at the t^{th} iteration based on the roulette rule, and the fluorescein of the firefly j is greater than the fluorescein of the firefly i.

In a specific embodiment, the target parameter further includes a decision domain. Decision domains of the respective fireflies are updated with a fourth formula, wherein the fourth formula is:

$${r}_{d}^{i} ( t + 1 ) = min \{ {r}_{s} , max \{ 0 , {r}_{d}^{i} ( t ) + β ( {n}_{i} - \vert {N}_{i} ( t ) ) \} \}$$

wherein r_{d}ⁱ(t+1) is a decision domain of the firefly i at the (t+1)^{th} iteration, rₛ is a preset perceptual domain, r_{d}ⁱ(t) is a decision domain of the firefly i at the t^{th} iteration, β is a dynamic decision domain update rate, nᵢ is a neighborhood set threshold, Nᵢ(t) is a neighborhood set of the firefly i at the t^{th} iteration.

In a specific embodiment, normalization is performed on the average power consumption, the average CPU utilization rate, and the average resource balance degree, wherein a normalization formula is:

$$\{ \begin{matrix}{f}_{p} = 1 - \frac{{f}_{p \_ o} - {f}_{p \_ min}}{{f}_{p \_ max} - {f}_{p \_ min}} \\ {f}_{cpu} = \frac{{f}_{cpu \_ o} - {f}_{cpu \_ min}}{{f}_{cpu \_ max} - {f}_{cpu \_ min}} \\ {f}_{load} = \frac{{f}_{load \_ o} - {f}_{load \_ min}}{{f}_{load \_ max} - {f}_{load \_ min}}\end{matrix}$$

wherein fₚ is the average power consumption after normalization, f_{p_o} is the average power consumption before normalization, f_{p_min} is a minimum average power consumption, and f_{p_max} is a maximum average power consumption; f_{cpu} is the average CPU utilization rate after normalization, f_{cpu_o} is the average CPU utilization rate before normalization, f_{cpu_min} is a minimum average CPU utilization rate, f_{cpu_max} is a maximum average CPU utilization rate; f_{load} is the average resource balance degree after normalization, f_{load_o} is the average resource balance degree before normalization, f_{load_min} is a minimum average resource balance degree, f_{load_max} is a maximum average resource balance degree.

The more specific operation processes of the various modules and units in the embodiment can refer to corresponding content disclosed in the preceding embodiments, which are not repeated here.

As can be seen, the virtual machine deployment apparatus provided by the embodiment can maximize the operation performance of all hosts in a cloud platform while scheduling virtual machines.

A virtual machine deployment device provided by an embodiment of the present application will be described below, which can refer to the virtual machine deployment method and apparatus described above.

Referring to FIG. 4, an embodiment of the present application discloses a virtual machine deployment device, including:
a memory 401, configured to store a computer program; and
a processor 402, configured to execute the computer program to implement the method of any of the above embodiments.

A readable storage medium provided by an embodiment of the present application will be described below, which can refer to the virtual machine deployment method, apparatus and device described above.

A readable storage medium is configured to store a computer program, wherein the computer program, when executed by a processor, implements the virtual machine deployment method disclosed by the preceding embodiments. Specific steps of the method can refer to corresponding content disclosed in the preceding embodiments, which are not repeated here.

“First,” “second,” “third,” “fourth,” or the like (if any) involved in the present application are used for distinguishing between similar objects and not used for describing a particular sequence or precedence order. It is to be understood that data so used may be interchanged under appropriate circumstances such that the embodiments described herein can be implemented in sequence other than those illustrated or described herein. Furthermore, the terms “include”, “comprise” and any variations thereof intend to cover non-exclusive inclusion, for example, a process, method or device that includes a list of steps or units is not necessarily limited to those steps or elements expressly listed but may include other steps or elements not expressly listed or inherent to such process, method or device.

It is to be noted that descriptions referring to “first”, “second”, etc., in the present application are for descriptive purposes only and are not to be understood as indicating or implying relative importance thereof or as implying the quantity of technical features indicated. Thus, a feature defined with “first” and “second” may explicitly or implicitly include at least one such feature. In addition, the technical solutions of the various embodiments may be combined with each other, but must be based on being implemented by a person of ordinary skill in the art. The combination of the technical solutions should be considered to be absent and not within the scope of protection claimed in the present application when such combination is contradictory or impossible to be implemented.

Various embodiments in the description are described in an incremental manner, wherein each embodiment focuses differences from the other embodiments, and the same or similar parts of the various embodiments may refer to each other.

The steps of the method or algorithm described in combination with the embodiments disclosed herein may be implemented directly by hardware, a software module executed by a processor, or a combination of the hardware and the software module. A software module may be arranged in a random access memory (RAM), a memory, a read only memory (ROM), an electrically programmable ROM, an electrically erasable programmable ROM, a register, a hard disk, a removable disk, a CD-ROM, or a readable storage medium in any other from known in the art.

The principles and embodiments of the present application are illustrated by applying examples, and the description of the above embodiments is only used to assist in understanding the method of the present application and its core concept. Meanwhile, for a person of ordinary in the art, changes may be made to the specific embodiments and application range based on the concept of the present application. In conclusion, the description should not be construed as limiting the present application.

What is claimed is:

1. A virtual machine deployment method, comprising:
randomly setting locations of respective fireflies and initializing target parameters of the respective fireflies, wherein the locations of the respective fireflies are locations of respective to-be-selected hosts;
taking the respective fireflies separately as to-be-processed objects, and performing a function calculation step to obtain target function values corresponding to the respective fireflies; the function calculation step comprising: calculating a target function according to the location of each of the to-be-processed objects, wherein the target function can represent an average performance score of all the to-be-selected hosts after assuming that a virtual machine has been deployed to each of the to-be-processed objects;
determining whether a maximum number of iterations is reached;
when the maximum number of iterations is reached, determining a firefly corresponding to the largest target function value among all target function values as a destination firefly, determining a to-be-selected host corresponding to the destination firefly as a destination host, and deploying the virtual machine to the destination host; and
when the maximum number of iterations is not reached, updating the target parameters of the respective fireflies, updating the locations of the respective fireflies according to the updated target parameters, and re-performing the step of taking the respective fireflies separately as the to-be-processed objects and performing the function calculation step to obtain target function values corresponding to the respective fireflies.

2. The virtual machine deployment method according to claim 1, wherein the calculation formula of the target function is:
$$F = {K}_{1} * \frac{{f}_{p}}{\sqrt{{f}_{p}^{2} + {{f}_{load}}^{2} + {{f}_{CPU}}^{2}}} + {K}_{2} * \frac{{f}_{load}}{\sqrt{{f}_{p}^{2} + {{f}_{load}}^{2} + {{f}_{CPU}}^{2}}} + {K}_{3} * \frac{{f}_{CPU}}{\sqrt{{f}_{p}^{2} + {{f}_{load}}^{2} + {{f}_{CPU}}^{2}}}$$
wherein F is the target function; fₚ is an average power consumption of the to-be-selected hosts after assuming that the virtual machine has been deployed to each of the to-be-processed objects; f_{CPU} is an average CPU utilization rate of all the to-be-selected hosts after assuming that the virtual machine has been deployed to each of the to-be-processed objects; f_{load} is an average resource balance degree of all the to-be-selected hosts after assuming that the virtual machine has been deployed to each of the to-be-processed objects; K₁, K₂ and K₃ are preset weight values, respectively.

3. The virtual machine deployment method according to claim 2, wherein the average resource balance degree is calculated based on the average CPU utilization rate, an average memory utilization rate, an average disk utilization rate, and an average bandwidth utilization rate of all the to-be-selected hosts after assuming that the virtual machine has been deployed to each of the to-be-processed objects; and the calculation formula of the average resource balance degree is:
$$\{ \begin{matrix}{f}_{load} = \frac{4}{{( \frac{{u}_{cpu}}{u} )}^{2} + {( \frac{{u}_{mem}}{u} )}^{2} + {( \frac{{u}_{hw}}{u} )}^{2} + {( \frac{{u}_{disk}}{u} )}^{2}} \\ u = \frac{{u}_{cpu} + {u}_{mem} + {u}_{hw} + {u}_{disk}}{4}\end{matrix}$$
wherein f_{load} is the average resource balance degree, u_{cpu} is the average CPU utilization rate, uₘₑₘ is the average memory utilization rate, u_{hw} is the average bandwidth utilization rate, and u_{disk} is the average disk utilization rate.

4. The virtual machine deployment method according to claim 1, wherein the target parameter comprises fluorescein and a step length; the step of updating the target parameters of the respective fireflies comprises:
updating fluorescein of the respective fireflies with a first formula, wherein the first formula is:
$${l}_{i} ( t + 1 ) = ( 1 - ρ ) {l}_{i} ( t ) + γ {F}_{i} ( t + 1 )$$
updating step lengths of the respective fireflies with a second formula, wherein the second formula is:
$$\{ \begin{matrix}{s}_{i} ( t + 1 ) = {s}_{min} + {( ( {s}_{max} - {s}_{min} ) {l}_{i} ( t ) )}^{c} \\ c = 1 + \frac{t + 1}{{t}_{max}} - cos ( \frac{t + 1}{{t}_{max}} )\end{matrix}$$
wherein lᵢ(t+1) is fluorescein of a firefly i at the (t+1)^{th} iteration, ρ(0 <ρ<1) is a fluorescein volatilization speed of the firefly i, lᵢ(t) is fluorescein of the firefly i at the t^{th} iteration, γ is a fluorescein update rate of the firefly i, Fᵢ(t+1) is a target function value of the firefly i at the (t+1)^{th} iteration, sᵢ(t+1) is a step length of the firefly i at the (t+1)^{th} iteration, sₘᵢₙ is a preset minimum step length, sₘₐₓ is a preset maximum step length, t+1 is the current number of iterations, and tₘₐₓ is the maximum number of iterations.

5. The virtual machine deployment method according to claim 4, wherein the step of updating the locations of the respective fireflies according to the updated target parameters comprises:
updating the locations of the respective fireflies with a third formula, wherein the third formula is:
$${x}_{i} ( t + 1 ) = {x}_{i} ( t ) + {s}_{i} ( t + 1 ) ( \frac{{x}_{j} ( t ) - {x}_{i} ( t )}{‖ {x}_{j} ( t ) - {x}_{i} ( t ) ‖} )$$
wherein xᵢ(t+1) is a location of the firefly i at the (t+1)^{th} iteration, xᵢ(t) is a location of the firefly i at the th iteration, sᵢ(t+1) is the step length of the firefly i at the (t+1)^{th} iteration, xⱼ(t) is a location of a firefly j at the t^{th} iteration, and ∥xⱼ(t)−xᵢ(t)∥ is a Euclidean distance between the location of the firefly i and the location of the firefly j; and
wherein the firefly j is a neighbor firefly selected within a decision domain of the firefly i at the t^{th} iteration based on the roulette rule, and the fluorescein of the firefly j is greater than the fluorescein of the firefly i.

6. The virtual machine deployment method according to claim 5, wherein the target parameter further comprises a decision domain; and decision domains of the respective fireflies are updated with a fourth formula, wherein the fourth formula is:
$${r}_{d}^{i} ( t + 1 ) = min \{ {r}_{s} , max \{ 0 , {r}_{d}^{i} ( t ) + β ( {n}_{i} - \vert {N}_{i} ( t ) ) \} \}$$
wherein r_{d}ⁱ(t+1) is a decision domain of the firefly i at the (t+1)^{th} iteration, rₛ is a preset perceptual domain, r_{d}ⁱ(t) is a decision domain of the firefly i at the t^{th} iteration, β is a dynamic decision domain update rate, nᵢ is a neighborhood set threshold, Nᵢ(t) is a neighborhood set of the firefly i at the t^{th} iteration.

7. The virtual machine deployment method according to claim 3, comprising: performing normalization on the average power consumption, the average CPU utilization rate, and the average resource balance degree, wherein a normalization formula is:
$$\{ \begin{matrix}{f}_{p} = 1 - \frac{{f}_{p \_ o} - {f}_{p \_ min}}{{f}_{p \_ max} - {f}_{p \_ min}} \\ {f}_{cpu} = \frac{{f}_{cpu \_ o} - {f}_{cpu \_ min}}{{f}_{cpu \_ max} - {f}_{cpu \_ min}} \\ {f}_{load} = \frac{{f}_{load \_ o} - {f}_{load \_ min}}{{f}_{load \_ max} - {f}_{load \_ min}}\end{matrix}$$
wherein fₚ is the average power consumption after normalization, f_{p_o} is the average power consumption before normalization, f_{p_min} is a minimum average power consumption, and f_{p_max} is a maximum average power consumption; f_{cpu} is the average CPU utilization rate after normalization, f_{cpu_o} is the average CPU utilization rate before normalization, f_{cpu_min} is a minimum average CPU utilization rate, f_{cpu_max} is a maximum average CPU utilization rate; f_{load} is the average resource balance degree after normalization, f_{load_o} is the average resource balance degree before normalization, f_{load_min} is a minimum average resource balance degree, f_{load_max} is a maximum average resource balance degree.

8. A virtual machine deployment apparatus, comprising:
an initialization module, configured to randomly set locations of respective fireflies and initialize target parameters of the respective fireflies, wherein the locations of the respective fireflies are locations of respective to-be-selected hosts;
a function calculation module, configured to take the respective fireflies separately as to-be-processed objects, and perform a function calculation step to obtain target function values corresponding to the respective fireflies; the function calculation step comprising: calculating a target function according to the location of each of the to-be-processed objects, wherein the target function can represent an average performance score of all the to-be-selected hosts after assuming that a virtual machine has been deployed to each of the to-be-processed objects;
a determination module, configured to determine whether a maximum number of iterations is reached;
a deployment module, configured to, when the maximum number of iterations is reached, determine a firefly corresponding to the largest target function value among all the target function values as a destination firefly, determine a to-be-selected host corresponding to the destination firefly as a destination host, and deploy the virtual machine to the destination host; and
an iteration module, configured to, when the maximum number of iterations is not reached, update the target parameters of the respective fireflies, update the locations of the respective fireflies according to the updated target parameters, and re-perform the step of taking the respective fireflies separately as the to-be-processed objects and performing the function calculation step to obtain target function values corresponding to the respective fireflies.

9. A virtual machine deployment device, comprising:
a memory, configured to store a computer program; and
a processor, configured to execute the computer program to implement the virtual machine deployment method according to any one of claims 1-7.

10. A readable storage medium, configured to store a computer program, wherein the computer program, when executed by a processor, implements the virtual machine deployment method according to any one of claims 1-7.
